(19) United States
(12) Patent Application Publication
(10) Pub. No.: US 2009/0119066 A1
(43) Pub. Date: May 7, 2009

(54) PROVIDING DIRECTIVE REPLACEMENT OF HFSI PARTS BASED ON SPECIFIC MACHINE PERFORMANCE

(76) Inventors: Alvin D. Strong, Palmyra, NY (US); Susan Layer, Fairport, NY (US)

Correspondence Address: Gibb Intellectual Property Law Firm, LLC, 2568-A Riva Road Suite 304, Annapolis, MD, 21401, US

(21) Appl. No.: 11/935,845

(22) Filed: Nov. 6, 2007

(51) Int. Cl. G06F 11/30

(52) U.S. Cl. 702/184; 399/24

(57) ABSTRACT

Embodiments herein maintain an unscheduled maintenance rate of a first apparatus, of a group of apparatuses, based on a history of unscheduled maintenance service calls performed on the first apparatus. Other apparatuses in the group of apparatuses have different unscheduled maintenance rates when compared to the unscheduled maintenance rate of the first apparatus. The method/system herein replaces fully used components of the first apparatus that exceed a predetermined full service life, based on usage meters of the components and replaces partially used components of the first apparatus that do not exceed the full service life, based on the usage meters. When directing replacement of partially used components, the method determines the remaining amount of the full service life for each of the partially used components, estimates the occurrence of the next service call for the first apparatus based on the unscheduled maintenance rate for the first apparatus, compares the remaining amount of the full service life for each of the partially used components to the occurrence of the next service call to identify ones of the partially used components that will exceed the full service life before the next service call, and then replaces only the ones of the partially used components that will exceed the full service life before the next service call.

### BACKGROUND AND SUMMARY

Embodiments herein generally relate to methods, systems, computer programs, services, etc. for replacing components within complex, heavily used devices that include large numbers of individual components to operate properly, such as copiers and printers, where such component replacement systems are based, in part, on the unscheduled maintenance rate of each specific apparatus.

Within complex, heavily used devices that include large numbers of individual components, HFSI (High Frequency Service Items) counters are used to provide customer service engineers (CSE's) warnings and replacement directives for parts that wear out at a consistent and predictable interval. When a service engineer makes a service call to service an apparatus, the service engineer generally replaces all components that are due for replacement and, at the service engineer's discretion, may replace warning level components. If an HFSI is due and the service engineer does not have the part, the service engineer returns later to replace the component.

In order to make service calls as effective as possible, yet avoid the unnecessary replacement of components, embodiments herein use the historical service rate of the machine (tracked by the machine itself) to determine if the replacement of a component that is nearing the end of its expected useful life can be postponed to the next scheduled or unscheduled service call. The embodiments herein can provide recommendations or directive actions to the service engineer for all “warning level” components (those nearing the end of their expected useful life) and can avoid leaving the decision of whether a component should be replace up to the service engineer.

One feature of embodiments herein is that each apparatus maintains its own historic interval of service calls. Thus, the embodiments herein determine whether it would be better to replace warning level components at the current service call or better to wait until the next service call so as to continue to get life out of the installed components. In dual engine systems that include duplicate, simultaneously operating components for example, the strategy for replacing sister components (the same one in two different engines) is complex. If an early failure occurs in the first engine, the embodiments herein analyze the situation and provide direction as to whether the same component in the second engine should be replaced.

More specifically, embodiments herein maintain an unscheduled maintenance rate of a first apparatus (that is one of a group or class of identical or substantially similar apparatuses). Most complex devices have a maintenance schedule and “scheduled maintenance” is performed according to such a maintenance schedule. However, occasionally, special service calls need to be made that are not on the maintenance schedule because a component breaks or become non-operable unexpectedly. Such special service calls are “unscheduled maintenance” (UM) calls.

With embodiments herein each separate device maintains its own “unscheduled maintenance” rate which is based on a history of unscheduled maintenance service calls performed on that specific device (which is sometimes referred to herein as a “first apparatus”). The unscheduled maintenance rate can comprise the number of unscheduled service operations performed over a period of time or over an operation measure of the first apparatus (e.g., number of items output, number of cycles run, number of hours of operation, etc.). Other apparatuses in the group or class of apparatuses to which the first apparatus belongs each will probably have different unscheduled maintenance rates when compared to the unscheduled maintenance rate of the “first apparatus.”

At each scheduled or unscheduled service call, embodiments herein replace “fully used” components of the first apparatus. Fully used components are those that are at (or exceed) a predetermined full service life, based on usage meters of the components. Again, such usage meters keep a record of the number of items output, number of cycles run, number of hours of operation, etc. of the apparatus in which they are positioned. In addition, the embodiments herein replace all non-operating (e.g., broken) components that have ceased to operate properly prior to the full service life. Embodiments herein also replace some “partially used” components of the first apparatus (e.g., components that have usage meter readings that do not exceed the full service life and are still operating properly) based on the process described below. Some of the partially used components can include duplicates of the non-operating components that are replaced.

More specifically, when identifying the partially used components that should be replaced, the embodiments herein determine the amount of the full service life that is remaining for each of the partially used components. This method also estimates the occurrence of a next service call (for the first apparatus) based on the unscheduled maintenance rate for the first apparatus (and looks to scheduled maintenance that will occur according to the maintenance schedule). This estimate of the occurrence of the next service call can be in units of time or operational units (mentioned above) of the first apparatus.

This allows the method to compare the remaining amount of the full service life for each of the partially used components to the occurrence of the next service call to identify which ones of the partially used components will exceed the full service life before the next service call is estimated to occur. It follows that the method calls for the replacement of such partially used components that will exceed the full service life before the next service call.

Embodiments also include a device that includes many components operatively connected to a controller. The controller operates the various components to produce a result. For example, in the case of a printing device, the controller controls the components to cause the components to print marking on printing media. As discussed above, once the apparatus has been operating for any significant amount of time, it will have fully used components and partially used components (and potentially non-operational, broken components).

The device embodiments herein also include a user interface (operatively connected to the controller) that is adapted to provide instructions regarding replacing the components. The controller maintains the unscheduled maintenance rate of the device. The controller also provides instructions on the user interface to replace fully used components the partially used (and/or broken) components. The controller determines the remaining amount of the full service life for each of the partially used components, estimates the occurrence of the next service call for the device, compares the remaining amount of the full service life for each of the partially used components to the occurrence of the next service call to identify ones of the partially used components that will exceed the full service life before the next service call, and provides instructions on the user interface to replace ones of the partially used components that will exceed the full service life before the next service call (the next scheduled service call according to the maintenance schedule, or the next unscheduled service call that is predicted based on the unscheduled maintenance history of the apparatus being serviced, whichever will occur first).

The unscheduled maintenance rate comprises the number of unscheduled service operations performed over a period of time or an operation measure of the first apparatus maintained by the controller. The full service life is based on a schedule calculated for apparatuses similar to the device maintained by the controller. The controller is further adapted to provide instructions on the user interface to replace non-operating components that have ceased to operate properly prior to the full service life. Again, the partially used components can include duplicates of the non-operating components.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a flow diagram illustrating embodiments herein; and

FIG. 3 is a cross-sectional schematic representation of an apparatus embodiment herein.

### DETAILED DESCRIPTION

As discussed above, in order to make service calls as effective as possible, yet avoid the unnecessary replacement of components, embodiments herein use the historical service rate of the machine (tracked by the machine itself) to determine if the replacement of a component that is nearing the end of its expected useful life can be postponed to the next scheduled (or unscheduled) service call. The embodiments herein can provide directive actions to the service engineer for all “warning level” components (those nearing the end of their expected useful life) and can avoid leaving the decision of whether a component should be replace up to the service engineer.

Certain parts in any complex device have very predictable failure rates and are critical to the reliability/function of the system. These are called HFSI's (High Frequency Service Items). Typical examples in printing devices are fuser rolls, photoreceptor belts, rolls etc. These parts are listed in a screen on the user interface each time a CSE makes a service call. The current age (based on the part's usage meter) of the component is displayed. Components that are nearing the end of their useful life can be highlighted in some manner (e.g., colored yellow (warning)) and those that have reached the expected end of their useful life can also be marked in some other manner (e.g., colored red). Service engineers are usually directed to replace those colored red, while the replacement of those colored yellow are left to the discretion of the service engineer. Service engineers use whatever knowledge they have about product part replacement interval and typical customer patterns to make a subjective judgment as whether to replace marginal (yellow) components.

However, the actions of service engineers can be inconsistent because of inconsistent experience levels, and service engineers may not always make good decisions regarding the replacement of components that are nearing the end of their expected useful life. Therefore, embodiments herein provide ways to take the guesswork out of such processes and to provide more directive actions. The embodiments herein provide a way to do this by having the machine use the current age, expected life and historical call rate on the specific machine to provide directive actions.

One feature of embodiments herein is that each apparatus maintains its own historic interval of service calls. Thus, the embodiments herein determine whether it would be better to replace warning level (yellow) components at the current service call or better to wait until the next service call, so as to continue to get life out of the installed components. In dual engine systems that include duplicate, simultaneously operating components for example, the strategy for replacing sister components (the same one in two different engines) is complex. If an early failure occurs in the first engine, the embodiments herein analyze the situation and provide direction as to whether the same component in the second engine should be replaced.

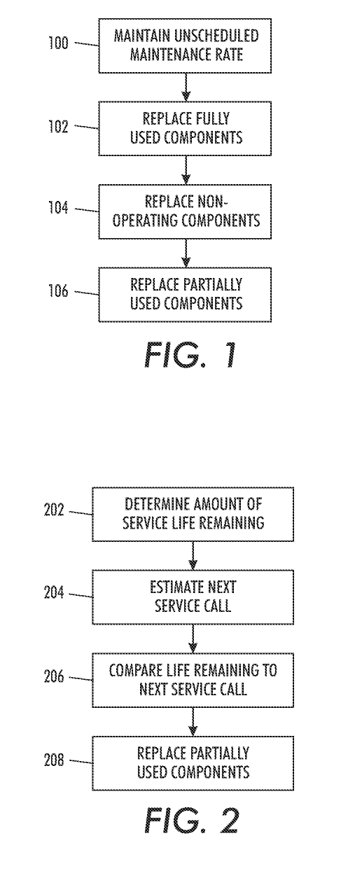

As shown in flowchart form in FIG. 1, embodiments herein maintain an unscheduled maintenance rate of a first apparatus (that is one of a group of identical or substantially similar apparatuses) in item 100. Most complex devices have a maintenance schedule that is based on the expected life of replaceable components and “scheduled maintenance” is performed according to such a maintenance schedule. However, occasionally, special service calls need to be made that are not on the maintenance schedule because a component breaks or become non-operable unexpectedly and before the component's expected life. Such special service calls are “unscheduled maintenance” (UM) calls.

With embodiments herein each separate device maintains its own “unscheduled maintenance” rate which is based on a history of unscheduled maintenance service calls performed on that specific device (which is sometimes referred to herein as the “first apparatus”). The unscheduled maintenance rate can comprise the number of unscheduled service operations performed over a period of time or over an operation measure of the first apparatus (e.g., number of items output, number of cycles run, number of hours of operation, etc.). Other apparatuses in the group or class of apparatuses to which the first apparatus belongs each can have different unscheduled maintenance rates when compared to the unscheduled maintenance rate of the first apparatus.

At each scheduled or unscheduled service call, embodiments herein replace (or direct replacement of) “fully used” components of the first apparatus in item 102. Fully used components are those that exceed a predetermined full service life, based on usage meters of the components. In addition, the embodiments herein replace (or direct replacement of) all non-operating (e.g., broken) components that have ceased to operate properly prior to the full service life in item 104. Embodiments herein also replace (or direct replacement of) some “partially used” components of the first apparatus (e.g., components that have usage meter readings that do not exceed the full service life) in item 106 based on the processing shown in FIG. 2. Some of the partially used components can include duplicates of the non-operating components that are replaced.

As shown in item 202 in FIG. 2, when identifying the partially used components that should be replaced, the embodiments herein determine the amount of the full service life that is remaining for each of the partially used components. This method also estimates the occurrence of the next service call (for the first apparatus) based on the unscheduled maintenance rate for the first apparatus (and looks to scheduled maintenance that will occur according to the maintenance schedule) in item 204. Thus, the next service call can be the next scheduled service call according to the maintenance schedule, or the next unscheduled service call that is predicted based on the unscheduled maintenance history of the apparatus being serviced, whichever occurs first. This estimate of the occurrence of the next service call can be in units of time or operational units (mentioned above) of the first apparatus.

This allows the method to compare the remaining amount of the full service life for each of the partially used components to the occurrence of the next service call in item 206 to identify which ones of the partially used components will exceed the full service life before the next service call is estimated to occur. It follows that the method (in item 208) calls for the replacement of such partially used components that will exceed the full service life before the next service call.

The operation of the embodiments can be seen using an example of a printing device component that has a life of 1 million prints and has a warning level of 800,000 prints. In this example, the component could display yellow on the user interface at 800,000 and red at 1 million. If a service call (scheduled or unscheduled) were performed right at the yellow value (800,000), it might be unclear whether it is best to replace the component (trying to prevent a future UM) or let it go until the next call (getting all life possible from the part). However, because with embodiments herein the device maintains its own unscheduled maintenance rate (UMR) (failure rate), embodiments herein can direct the service engineer as to the highest probability of the correct answer. If the machine unscheduled maintenance rate is running at 4 calls/million, then replacing it at the current service call will likely save a unscheduled maintenance call in the near future. However, if the machine is running at 8 calls/million, then the part can be left in until the next call and the additional life gotten from the part. In other words, if an apparatus has a higher number of unscheduled maintenance calls, it will receive maintenance more frequently and presents a lower probability of needing to replace partially used components.

Some dual engine devices (printing devices having dual printing engines) have policies that leave the decision on sister part replacement to the service engineer's discretion. In general, it is expected that the CSE's will change both components at the same time (e.g., both photoreceptors, both fuser rolls, etc.). However, the financial analysis behind this (when unusually early failures are involved) would benefit from embodiments herein by reducing the number of automatic sister part replacements. For example, assume one printing engine's photoconductor belt fails prematurely at 300,000 prints (assuming an expected life of 1 million prints). Most likely the second belt would not need to be replaced. However, now consider the second belts replacement 700,000 prints later (at the second belt's 1 million print mark). In this situation, the first belt has only 300 K left before it needs to be replaced. The historical unscheduled maintenance rate could be used to determine the best course of action. Thus, if the device were experiencing unscheduled maintenance calls at every 250,000 prints, the first belt would not need to be replaced with the second belt; however, if unscheduled maintenance calls were only occurring every 500,000 prints, it would be best to replace the first and second belts at the 1 million print mark.

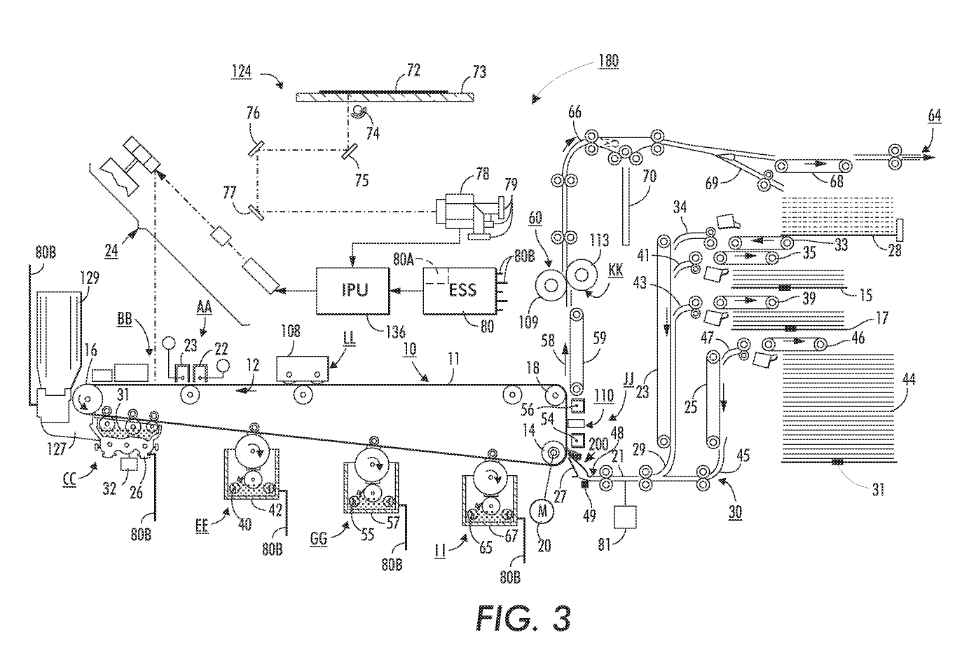

Embodiments also include a device that includes many components operatively connected to a controller, as shown in FIG. 3. The controller operates the various components to produce a result. For example, in the case of a printing device, the controller 80 controls the components to cause the components to print marking on printing media. As discussed above, once the apparatus has been operating for any significant amount of time, it will have fully used components and partially used components (and potentially non-operational, broken components).

The device embodiments herein also include a user interface 83 (operatively connected to or included as part of the controller 80) that is adapted to provide instructions regarding replacing the components. The controller 80 maintains the unscheduled maintenance rate of the device on internal or external electronic memory.

The controller 80 also provides instructions on the user interface 83 to replace fully used components and the partially used (and/or broken) components. The controller 80 determines the remaining amount of the full service life for each of the partially used components, estimates the occurrence of the next service call for the device, compares the remaining amount of the full service life for each of the partially used components to the occurrence of the next service call to identify ones of the partially used components that will exceed the full service life before the next service call, and provides instructions on the user interface 83 to replace ones of the partially used components that will exceed the full service life before the next service call.

The unscheduled maintenance rate comprises the number of unscheduled service operations performed over a period of time or an operation measure of the first apparatus maintained by the controller 80. The full service life is based on a schedule calculated for apparatuses similar to the device (a given class or group) maintained by the controller 80. The controller 80 is further adapted to provide instructions on the user interface 83 to replace non-operating components that have ceased to operate properly prior to the full service life. Again, the partially used components can include duplicates of the non-operating components.

Additionally, the embodiments herein allow a service engineer to query a connected machine prior to going on the call for what HSFI's should be replaced. This would allow the CSE to make sure she has the parts before going on-site. This would be especially helpful in remote areas where travel time/expense will be minimized.

Thus, embodiments herein include a device that has the ability to print and which may also be able to scan and perform processing on documents, communicate with remote entities, etc. There are many devices currently available that have these abilities, such as copiers, fax machines, multifunction printers, etc., and the embodiments herein are intended to operate with all such machines as well as other devices. The term “printing device” as used herein encompasses any such digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. Printers are readily available devices produced by manufactures such as Xerox Corporation, Stamford, Conn., USA. Such printers commonly include input/output, power supplies, processors, media movement devices, marking devices etc., the details of which are omitted herefrom to allow the reader to focus on the salient aspects of the embodiments described herein. FIG. 3 illustrates an exemplary device in which the module embodiments herein operate with high effectiveness.

More specifically, FIG. 3 illustrates an exemplary electrostatographic reproduction machine, for example, a multipass color electrostatographic reproduction machine 180. As is well known, the color copy process typically involves a computer generated color image which may be conveyed to an image processor 136, or alternatively a color document 72 which may be placed on the surface of a transparent platen 73. A scanning assembly 124, having a light source 74 illuminates the color document 72. The light reflected from document 72 is reflected by mirrors 75, 76, and 77, through lenses (not shown) and a dichroic prism 78 to three charged-coupled linear photosensing devices (CCDs) 79 where the information is read. Each CCD 79 outputs a digital image signal the level of which is proportional to the intensity of the incident light. The digital signals represent each pixel and are indicative of blue, green, and red densities. They are conveyed to the IPU 136 where they are converted into color separations and bit maps, typically representing yellow, cyan, magenta, and black. IPU 136 stores the bit maps for further instructions from an electronic subsystem (ESS).

The ESS is preferably a self-contained, dedicated mini-computer having a central processor unit (CPU), electronic storage, and a display or graphic user interface (GUI) 83. The ESS is the control system which, with the help of sensors, and connections 80B as well as a pixel counter 80A, reads, captures, prepares and manages the image data flow between IPU 136 and image input terminal 124. In addition, the ESS 80 is the main multi-tasking processor for operating and controlling all of the other machine subsystems and printing operations. These printing operations include imaging, development, sheet delivery and transfer, and particularly control of the sequential transfer assist blade assembly. Such operations also include various functions associated with subsequent finishing processes. Some or all of these subsystems may have micro-controllers that communicate with the ESS 80.

The multipass color electrostatographic reproduction machine 180 employs a photoreceptor 10 in the form of a belt having a photoconductive surface layer 11 on an electroconductive substrate. The surface 11 can be made from an organic photoconductive material, although numerous photoconductive surfaces and conductive substrates may be employed. The belt 10 is driven by means of motor 20 having an encoder attached thereto (not shown) to generate a machine timing clock. Photoreceptor 10 moves along a path defined by rollers 14, 18, and 16 in a counter-clockwise direction as shown by arrow 12.

Initially, in a first imaging pass, the photoreceptor 10 passes through charging station AA where a corona generating devices, indicated generally by the reference numeral 22, 23, on the first pass, charge photoreceptor 10 to a relatively high, substantially uniform potential. Next, in this first imaging pass, the charged portion of photoreceptor 10 is advanced through an imaging station BB. At imaging station BB, the uniformly charged belt 10 is exposed to the scanning device 24 forming a latent image by causing the photoreceptor to be discharged in accordance with one of the color separations and bit map outputs from the scanning device 24, for example black. The scanning device 24 is a laser Raster Output Scanner (ROS). The ROS creates the first color separatism image in a series of parallel scan lines having a certain resolution, generally referred to as lines per inch. Scanning device 24 may include a laser with rotating polygon mirror blocks and a suitable modulator, or in lieu thereof, a light emitting diode array (LED) write bar positioned adjacent the photoreceptor 10.

At a first development station CC, a non-interactive development unit, indicated generally by the reference numeral 26, advances developer material 31 containing carrier particles and charged toner particles at a desired and controlled concentration into contact with a donor roll, and the donor roll then advances charged toner particles into contact with the latent image and any latent target marks. Development unit 26 may have a plurality of magnetic brush and donor roller members, plus rotating augers or other means for mixing toner and developer. These donor roller members transport negatively charged black toner particles for example, to the latent image for development thereof which tones the particular (first) color separation image areas and leaves other areas untoned. Power supply 32 electrically biases development unit 26. Development or application of the charged toner particles as above typically depletes the level and hence concentration of toner particles, at some rate, from developer material in the development unit 26. This is also true of the other development units (to be described below) of the machine 180.

On the second and subsequent passes of the multipass machine 180, the pair of corona devices 22 and 23 are employed for recharging and adjusting the voltage level of both the toned (from the previous imaging pass), and untoned areas on photoreceptor 10 to a substantially uniform level. A power supply is coupled to each of the electrodes of corona recharge devices 22 and 23. Recharging devices 22 and 23 substantially eliminate any voltage difference between toned areas and bare untoned areas, as well as to reduce the level of residual charge remaining on the previously toned areas, so that subsequent development of different color separation toner images is effected across a uniform development field.

Imaging device 24 is then used on the second and subsequent passes of the multipass machine 180, to superimpose subsequent a latent image of a particular color separation image, by selectively discharging the recharged photoreceptor 10. The operation of imaging device 24 is of course controlled by the controller, ESS 80. One skilled in the art will recognize that those areas developed or previously toned with black toner particles will not be subjected to sufficient light from the imaging device 24 as to discharge the photoreceptor region lying below such black toner particles. However, this is of no concern as there is little likelihood of a need to deposit other colors over the black regions or toned areas.

Thus on a second pass, imaging device 24 records a second electrostatic latent image on recharged photoreceptor 10. Of the four development units, only the second development unit 42, disposed at a second developer station EE, has its development function turned “on” (and the rest turned “off”) for developing or toning this second latent image. As shown, the second development unit 42 contains negatively charged developer material 40, for example, one including yellow toner. The toner 40 contained in the development unit 42 is thus transported by a donor roll to the second latent image recorded on the photoreceptor 10, thus forming additional toned areas of the particular color separation on the photoreceptor 10. A power supply (not shown) electrically biases the development unit 42 to develop this second latent image with the negatively charged yellow toner particles 40. As will be further appreciated by those skilled in the art, the yellow colorant is deposited immediately subsequent to the black so that further colors that are additive to yellow, and interact therewith to produce the available color gamut, can be exposed through the yellow toner layer.

On the third pass of the multipass machine 180, the pair of corona recharge devices 22 and 23 are again employed for recharging and readjusting the voltage level of both the toned and untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas, as well as to reduce the level of residual charge remaining on the previously toned areas so that subsequent development of different color toner images is effected across a uniform development field. A third latent image is then again recorded on photoreceptor 10 by imaging device 24. With the development functions of the other development units turned “off”, this image is developed in the same manner as above using a third color toner 55 contained in a development unit 57 disposed at a third developer station GG. An example of a suitable third color toner is magenta. Suitable electrical biasing of the development unit 57 is provided by a power supply, not shown.

On the fourth pass of the multipass machine 180, the pair of corona recharge devices 22 and 23 again recharge and adjust the voltage level of both the previously toned and yet untoned areas on photoreceptor 10 to a substantially uniform level. A power supply is coupled to each of the electrodes of corona recharge devices 22 and 23. The recharging devices 22 and 23 substantially eliminate any voltage difference between toned areas and bare untoned areas as well as to reduce the level of residual charge remaining on the previously toned areas. A fourth latent image is then again created using imaging device 24. The fourth latent image is formed on both bare areas and previously toned areas of photoreceptor 10 that are to be developed with the fourth color image. This image is developed in the same manner as above using, for example, a cyan color toner 65 contained in development unit 67 at a fourth developer station II. Suitable electrical biasing of the development unit 67 is provided by a power supply, not shown.

Following the black development unit 26, development units 42, 57, and 67 are preferably of the type known in the art which do not interact, or are only marginally interactive with previously developed images. For examples, a DC jumping development system, a powder cloud development system, or a sparse, non-contacting magnetic brush development system are each suitable for use in an image on image color development system as described herein. In order to condition the toner for effective transfer to a substrate, a negative pre-transfer corotron member negatively charges all toner particles to the required negative polarity to ensure proper subsequent transfer.

Since the machine 180 is a multicolor, multipass machine as described above, only one of the plurality of development units, 26, 42, 57 and 67 may have its development function turned “on” and operating during any one of the required number of passes, for a particular color separation image development. The remaining development units thus have their development functions turned off.

During the exposure and development of the last color separation image, for example by the fourth development unit 65, 67 a sheet of support material is advanced to a transfer station JJ by a sheet feeding apparatus 30. During simplex operation (single sided copy), a blank sheet may be fed from tray 15 or tray 17, or a high capacity tray 44 could thereunder, to a registration transport 21, in communication with controller 81, where the sheet is registered in the process and lateral directions, and for skew position. As shown, the tray 44 and each of the other sheet supply sources includes a sheet size sensor 31 that is connected to the controller 80. One skilled in the art will realize that trays 15, 17, and 44 each hold a different sheet type.

The speed of the sheet is adjusted at registration transport 21 so that the sheet arrives at transfer station JJ in synchronization with the composite multicolor image on the surface of photoconductive belt 10. Registration transport 21 receives a sheet from either a vertical transport 23 or a high capacity tray transport 25 and moves the received sheet to pretransfer baffles 27. The vertical transport 23 receives the sheet from either tray 15 or tray 17, or the single-sided copy from duplex tray 28, and guides it to the registration transport 21 via a turn baffle 29. Sheet feeders 35 and 39 respectively advance a copy sheet from trays 15 and 17 to the vertical transport 23 by chutes 41 and 43. The high capacity tray transport 25 receives the sheet from tray 44 and guides it to the registration transport 21 via a lower baffle 45. A sheet feeder 46 advances copy sheets from tray 44 to transport 25 by a chute 47.

As shown, pretransfer baffles 27 guide the sheet from the registration transport 21 to transfer station JJ. Charge can be placed on the baffles from either the movement of the sheet through the baffles or by the corona generating devices 54, 56 located at marking station or transfer station JJ. Charge limiter 49 located on pretransfer baffles 27 and 48 restricts the amount of electrostatic charge a sheet can place on the baffles 27 thereby reducing image quality problems and shock hazards. The charge can be placed on the baffles from either the movement of the sheet through the baffles or by the corona generating devices 54, 56 located at transfer station JJ. When the charge exceeds a threshold limit, charge limiter 49 discharges the excess to ground.

Transfer station JJ includes a transfer corona device 54 which provides positive ions to the backside of the copy sheet. This attracts the negatively charged toner powder images from photoreceptor belt 10 to the sheet. A detack corona device 56 is provided for facilitating stripping of the sheet from belt 10. A sheet-to-image registration detector 110 is located in the gap between the transfer and corona devices 54 and 56 to sense variations in actual sheet to image registration and provides signals indicative thereof to ESS 80 and controller 81 while the sheet is still tacked to photoreceptor belt 10.

The transfer station JJ also includes the transfer assist blade assembly 200, in which various segmented blades are engaged for contacting the backside of the image receiving sheet. After transfer, the sheet continues to move, in the direction of arrow 58, onto a conveyor 59 that advances the sheet to fusing station KK.

Fusing station KK includes a fuser assembly, indicated generally by the reference numeral 60, which permanently fixes the transferred color image to the copy sheet. Preferably, fuser assembly 60 comprises a heated fuser roller 109 and a backup or pressure roller 113. The copy sheet passes between fuser roller 109 and backup roller 113 with the toner powder image contacting fuser roller 109. In this manner, the multi-color toner powder image is permanently fixed to the sheet. After fusing, chute 66 guides the advancing sheet to feeder 68 for exit to a finishing module (not shown) via output 64. However, for duplex operation, the sheet is reversed in position at inverter 70 and transported to duplex tray 28 via chute 69. Duplex tray 28 temporarily collects the sheet whereby sheet feeder 33 then advances it to the vertical transport 23 via chute 34. The sheet fed from duplex tray 28 receives an image on the second side thereof, at transfer station JJ, in the same manner as the image was deposited on the first side thereof. The completed duplex copy exits to the finishing module (not shown) via output 64.

After the sheet of support material is separated from photoreceptor 10, the residual toner carried on the photoreceptor surface is removed therefrom. The toner is removed for example at cleaning station LL using a cleaning brush structure contained in a unit 108.

The embodiments herein comprise complete printing devices, such as the one shown in FIG. 3, or simply single modules of a printing device (e.g., an ESS 80, for example) and are specifically directed to electrostatographic and xerographic devices.

Thus, as shown above, embodiments herein maintain an unscheduled maintenance rate of a first apparatus, of a group of apparatuses, based on a history of unscheduled maintenance service calls performed on the first apparatus. Other apparatuses in the group of apparatuses have different unscheduled maintenance rates when compared to the unscheduled maintenance rate of the first apparatus. The method/system herein replaces fully used components of the first apparatus that exceed a predetermined full service life, based on usage meters of the components and replaces partially used components of the first apparatus that do not exceed the full service life, based on the usage meters.

When replacing partially used components, the method determines the remaining amount of the full service life for each of the partially used components, estimates the occurrence of the next service call for the first apparatus based on the unscheduled maintenance rate for the first apparatus, compares the remaining amount of the full service life for each of the partially used components to the occurrence of the next service call to identify ones of the partially used components that will exceed the full service life before the next service call, and then replaces only the ones of the partially used components that will exceed the full service life before the next service call.

By limiting when partially used components can be replaced, the embodiments herein allow components to be used for more of their useful life, thereby minimizing the cost of replacement parts. Further, by basing partially used component replacement on each individual apparatus' unscheduled maintenance history, the likelihood that a decision to not replace a partially used component will cause an unscheduled maintenance call is reduced. Therefore, the embodiments herein balance the costs of replacement components against the cost of unscheduled maintenance calls.

Some conventional methods represent unscheduled events in a service plan (e.g., see U.S. Patent Publication 2006/111871, which is incorporated herein by reference). Other methods adjust the amount of parts replaced so to minimize the number of service calls (e.g., see U.S. Patent Publication 2002/178067, which is incorporated herein by reference). The embodiments herein are not apparent from concepts that forecast the need for replacement parts based on average needs of all devices within a given group or that focus on minimizing the number of service calls at the expense of replacing parts early because the embodiments herein break away from such teachings by relying upon the individual repair history of a specific device.

Individual repair histories might indicate that a specific apparatus has recently received an unusually large amount of service and may not need service for an extended period of time, in that the large amount of recent service would have cured most of that device's problems. Further, it could be contemplated that all devices will come to the average position, promoting a conclusion that an unusually large amount of previous service calls would “average out” to a smaller number of subsequent service calls (i.e., previous service would logically result in a reduced amount of future service). However, the embodiments herein act in contrast to such concepts by determining that a device that is experiencing a larger than average repair history is likely to be in an environment that will continue to cause it to suffer from a greater number of repairs than the average. Therefore, these embodiments produce an unexpected result by concluding that higher levels of previous service will provide a prediction of higher levels of future service. The embodiments herein actually take advantage of such a situation by making a prediction that the specific high repair history device will continue to receive more frequent than average repair visits and that marginal partially used components can be allowed to remain in such devices longer without causing failure.

In order to make service calls as effective as possible, yet avoid the unnecessary replacement of components, embodiments produce an unexpected benefit by using the historical service rate of the machine (tracked by the machine itself) to determine if the replacement of a component that is nearing the end of its expected useful life can be postponed to the next scheduled or unscheduled service call. The embodiments herein can provide recommendations or directive actions to the service engineer for all “warning level” components (those nearing the end of their expected useful life) and can avoid leaving the decision of whether a component should be replace up to the service engineer.

All foregoing embodiments are specifically applicable to electrostatographic and/or xerographic machines and/or processes as well as to software programs stored on the electronic memory 80 (computer usable data carrier) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
maintaining an unscheduled maintenance rate of a first apparatus;
directing replacement of fully used components of said first apparatus that exceed a predetermined full service life, based on usage meters of said components; and
directing replacement of partially used components of said first apparatus that do not exceed said full service life, based on said usage meters, according to a method comprising:
determining a remaining amount of said full service life for each of said partially used components;
estimating an occurrence of a next service call for said first apparatus based on said unscheduled maintenance rate for said first apparatus;
comparing said remaining amount of said full service life for each of said partially used components to said occurrence of said next service call to identify ones of said partially used components that will exceed said full service life before said next service call; and
directing replacement of ones of said partially used components that will exceed said full service life before said next service call.

2. The method according to claim 1, all the limitations of which are incorporated by reference, wherein said unscheduled maintenance rate comprises a number of unscheduled service operations performed over one of a period of time and an operation measure of said first apparatus.

3. The method according to claim 1, all the limitations of which are incorporated by reference, wherein said directing replacement of said fully used components and said directing replacement of said partially used components occurs at one of an unscheduled and a scheduled maintenance service operation.

4. The method according to claim 1, all the limitations of which are incorporated by reference, wherein said full service life is based on a schedule calculated for apparatuses similar to said first apparatus.

5. The method according to claim 1, all the limitations of which are incorporated by reference, further comprising directing replacement of non-operating components that have ceased to operate properly prior to said full service life, and wherein said partially used components include duplicates of said non-operating components.

6. A method comprising:
maintaining an unscheduled maintenance rate of a first apparatus, of a group of apparatuses, based on a history of unscheduled maintenance service calls performed on said first apparatus, wherein other apparatuses in said group of apparatuses have different unscheduled maintenance rates when compared to said unscheduled maintenance rate of said first apparatus;
directing replacement of fully used components of said first apparatus that exceed a predetermined full service life, based on usage meters of said components; and
directing replacement of partially used components of said first apparatus that do not exceed said full service life, based on said usage meters, according to a method comprising:
determining a remaining amount of said full service life for each of said partially used components;
estimating an occurrence of a next service call for said first apparatus based on said unscheduled maintenance rate for said first apparatus;
comparing said remaining amount of said full service life for each of said partially used components to said occurrence of said next service call to identify ones of said partially used components that will exceed said full service life before said next service call; and
directing replacement of ones of said partially used components that will exceed said full service life before said next service call.

7. The method according to claim 6, all the limitations of which are incorporated by reference, wherein said unscheduled maintenance rate comprises a number of unscheduled service operations performed over one of a period of time and an operation measure of said first apparatus.

8. The method according to claim 6, all the limitations of which are incorporated by reference, wherein said directing replacement of said fully used components and said directing replacement of said partially used components occurs at one of an unscheduled and a scheduled maintenance service operation.

9. The method according to claim 6, all the limitations of which are incorporated by reference, wherein said full service life is based on a schedule calculated for apparatuses similar to said first apparatus.

10. The method according to claim 6, all the limitations of which are incorporated by reference, further comprising directing replacement of non-operating components that have ceased to operate properly prior to said full service life, and wherein said partially used components include duplicates of said non-operating components.

11. A computer program product comprising:
a computer-usable data carrier storing instructions that, when executed by a computer, cause the computer to perform a method comprising:
maintaining an unscheduled maintenance rate of a first apparatus;
directing replacement of fully used components of said first apparatus that exceed a predetermined full service life, based on usage meters of said components; and
directing replacement of partially used components of said first apparatus that do not exceed said full service life, based on said usage meters, according to a method comprising:
determining a remaining amount of said full service life for each of said partially used components;
estimating an occurrence of a next service call for said first apparatus based on said unscheduled maintenance rate for said first apparatus;
comparing said remaining amount of said full service life for each of said partially used components to said occurrence of said next service call to identify ones of said partially used components that will exceed said full service life before said next service call; and
directing replacement of ones of said partially used components that will exceed said full service life before said next service call.

12. The computer program product according to claim 11, all the limitations of which are incorporated by reference, wherein said unscheduled maintenance rate comprises a number of unscheduled service operations performed over one of a period of time and an operation measure of said first apparatus.

13. The computer program product according to claim 11, all the limitations of which are incorporated by reference, wherein said directing replacement of said fully used components and said directing replacement of said partially used components occurs at one of an unscheduled and a scheduled maintenance service operation.

14. The computer program product according to claim 11, all the limitations of which are incorporated by reference, wherein said full service life is based on a schedule calculated for apparatuses similar to said first apparatus.

15. The computer program product according to claim 11, all the limitations of which are incorporated by reference, further comprising directing replacement of non-operating components that have ceased to operate properly prior to said full service life, and wherein said partially used components include duplicates of said non-operating components.

16. A printing device comprising:
a controller;
components operatively connected to said controller, wherein said controller controls said components to cause said components to print marking on printing media, wherein said components comprise fully used components and partially used components; and
a user interface operatively connected to said controller and adapted to provide instructions regarding directing replacement of said components, wherein said controller is adapted to:
maintaining an unscheduled maintenance rate of a printing device;
provide instructions on said user interface to replace fully used components of said printing device that exceed a predetermined full service life, based on usage meters of said components; and
provide instructions on said user interface to replace partially used components of said printing device that do not exceed said full service life, based on said usage meters, according to a method comprising:
determining a remaining amount of said full service life for each of said partially used components;
estimating an occurrence of a next service call for said printing device based on said unscheduled maintenance rate for said printing device;
comparing said remaining amount of said full service life for each of said partially used components to said occurrence of said next service call to identify ones of said partially used components that will exceed said full service life before said next service call; and
provide instructions on said user interface to replace ones of said partially used components that will exceed said full service life before said next service call.

17. The printing device according to claim 16, all the limitations of which are incorporated by reference, wherein said unscheduled maintenance rate comprises a number of unscheduled service operations performed over one of a period of time and an operation measure of said first apparatus maintained by said controller.

18. The printing device according to claim 16, all the limitations of which are incorporated by reference, wherein said full service life is based on a schedule calculated for apparatuses similar to said printing device maintained by said controller.

19. The printing device according to claim 16, all the limitations of which are incorporated by reference, wherein said controller is further adapted to provide instructions on said user interface to replace non-operating components that have ceased to operate properly prior to said full service life, and wherein said partially used components include duplicates of said non-operating components.

20. The printing device according to claim 16, all the limitations of which are incorporated herein by reference, wherein said printing device comprises one of an electrostatographic device and a xerographic device.
